(19) United States
(12) Patent Application Publication
(10) Pub. No.: US 2009/0179429 A1
(43) Pub. Date: Jul. 16, 2009

(54) Efficient low temperature thermal energy storage

(76) Inventors: Erik Ellis, Phoenix, AZ (US); Milton Venetos, Los Altos, CA (US)

Correspondence Address: MORRISON & FOERSTER LLP, 755 PAGE MILL RD, PALO ALTO, CA, 94304-1018, US

(21) Appl. No.: 12/291,405

(22) Filed: Nov. 10, 2008

Related U.S. Application Data
(60) Provisional application No. 60/986,978, filed on Nov. 9, 2007.

(51) Int. Cl. F02B 63/04; F03G 6/06; F01K 25/00; F03G 7/10

(52) U.S. Cl. 290/1 R; 60/641.15; 60/671; 60/651; 415/916

(57) ABSTRACT

Thermal energy derived from a low temperature heat source is stored in one reservoir above ambient temperature and in another reservoir below ambient temperature for use in driving an organic Rankine cycle engine to produce electricity. The organic Rankine cycle engine may utilize an organic working fluid that boils below or near ambient temperature. Solar energy may be used to power a heat pump or chiller that provides the hot and cold storage fluids stored in hot and cold reservoirs for use in the organic Rankine cycle engine.

### RELATED APPLICATIONS

This application claims the benefit of priority to U.S. application Ser. No. 60/986,978 filed Nov. 9, 2007 and entitled “Thermal Energy Storage Through the Use of Mechanically Driven Chillers and Insulated Water Holding Tanks,” inventors E. Ellis and M. Venetos, the contents of which are incorporated by reference in their entirety herein as if put forth in full below.

### FIELD

The apparatus and methods described herein concern the storage of low temperature thermal energy and the efficient conversion of such stored thermal energy to generate electricity.

### BACKGROUND

High peak loads drive the capital expenditures of the electricity generation industry. Currently, the industry meets these peak loads with additional capacity, including for example, low-efficiency peaking power plants, usually gas turbines, which have lower capital costs but higher fuel costs. As an alternative to adding additional capacity during peak loads, energy storage has great potential to provide electricity to match demand and would be cheaper in both economic and environmental terms.

Thermal energy storage technologies store heat in an insulated repository for later use in electricity generation. Thermal energy storage allows a solar thermal plant, for example, to produce energy at night or on overcast days. With thermal energy storage, power generation can become more reliable, can be sold during peak use periods for higher prices, and can allow for less expensive generation equipment.

Traditionally, the goal is to transfer thermal energy to a substance which can store heat with a high energy temperature, like molten salt, oil, or high temperature/pressure steam. It is thought that high energy temperature storage is necessary to maintain a reasonable efficiency when converted to electricity. For example, the PS10 solar power tower stores heat in tanks as pressurized steam at 50 bar and 285° C.

Low temperature thermal storage with efficient conversion to electricity or other work could allow for effective utilization of low grade heat, as well as lower cost and more scalable storage options.

### BRIEF SUMMARY

Provided herein are systems and methods that may utilize low temperature heat sources, e.g. heat transfer fluids at ambient pressure or waste heat, to produce useful work such as generating electricity.

In one instance, a system comprises (a) a hot reservoir configured to retain a first storage fluid; (b) a cold reservoir configured to retain a second storage fluid; and (c) a first heat engine in fluid communication with the hot reservoir and the cold reservoir. The first heat engine is configured to remove heat from the second storage fluid and transfer that heat into the first storage fluid. The system also comprises (d) a second heat engine in fluid communication with the hot reservoir and the cold reservoir, the second heat engine having an organic working fluid and being configured to transfer heat from the first storage fluid into the organic working fluid and also being configured to transfer heat from the organic working fluid into the second storage fluid; and (e) an electrical generator coupled to the second heat engine.

In another instance, a method of producing electricity comprises: (a) removing heat from a first storage fluid in a cold reservoir to produce colder first storage fluid; (b) transferring said heat to a second storage fluid in a hot reservoir to produce hotter second storage fluid; (c) evaporating an organic working fluid using heat from the hotter second storage fluid; (d) using the. organic working fluid to generate electricity; and (e) cooling the organic working fluid using the colder first storage fluid.

In a specific instance, a system comprises a Rankine turbine configured to receive a low temperature steam containing heat that was originally generated using e.g. solar energy from a linear Fresnel reflector array; a heat pump coupled to the Rankine turbine through a first shaft; an electrical generator coupled to the Rankine turbine through a second shaft; a hot reservoir in heat exchange relationship with the heat pump, the Rankine turbine, and an organic cycle Rankine turbine; a cold reservoir in heat exchange relationship with the heat pump and the organic cycle Rankine turbine; and a third shaft connecting the organic cycle Rankine turbine to the electrical generator above or to another electrical generator.

Also provided are a power plant and a method of retrofitting an existing power plant. Systems and methods as discussed herein may, in many instances, improve efficiency of heat utilization in a power plant.

### BRIEF DESCRIPTION OF THE DRAWINGS

FIG. 1 depicts one variation of a power generation system with one or more hot and cold reservoirs.

FIG. 2 illustrates a typical computing system that may be employed to carry out processing functionality in some variations of the methods described herein.

### DETAILED DESCRIPTION

In order to provide a more thorough understanding of the apparatus and methods described herein, the following description and calculations set forth numerous specific details, such as specific methods, parameters, examples, and the like. It should be recognized, however, that such description is not intended as a limitation on the scope of the apparatus and methods described herein, but is intended to provide a better understanding of the possible variations. Although headings are provided in the description below for convenience, the headings are not to be construed to limit the detailed description in any way.

A system as described herein may be retrofitted to an existing power plant to enable the power plant to provide additional power during peak periods, for instance. A system may be incorporated into a new or existing plant to enable the plant to operate more efficiently by extracting energy from low-temperature process streams and generating electricity with that energy. Low temperature process streams include those in which fluid is used at standard or ambient pressure, e.g. water or steam at about 1 atm.

The term “heat engine” is used in a broad sense herein. A heat engine may convert thermal energy to mechanical energy and/or electrical energy, or a heat engine may convert electrical or mechanical energy to heat. Thus, heat engines include steam turbines, Stirling engines, pseudo-Stirling cycles, Carnot cycles, Ericsson cycles, Kalina cycles, Stoddard engines and the like alone or attached to an electricity generator, and heat engines include chillers and heat pumps.

In one exemplary system, low-temperature steam (e.g. saturated steam) from e.g. a solar energy collector system drives a first heat engine such as a heat pump or chiller to create cold and hot fluids in a cold and a hot temperature reservoir, respectively, and the heat stored in the reservoirs is subsequently or concurrently used to drive a second heat engine to generate energy, e.g. electricity. Useful work is thus derived from process streams that have, in the past, been uneconomical sources of energy, e.g. electric power.

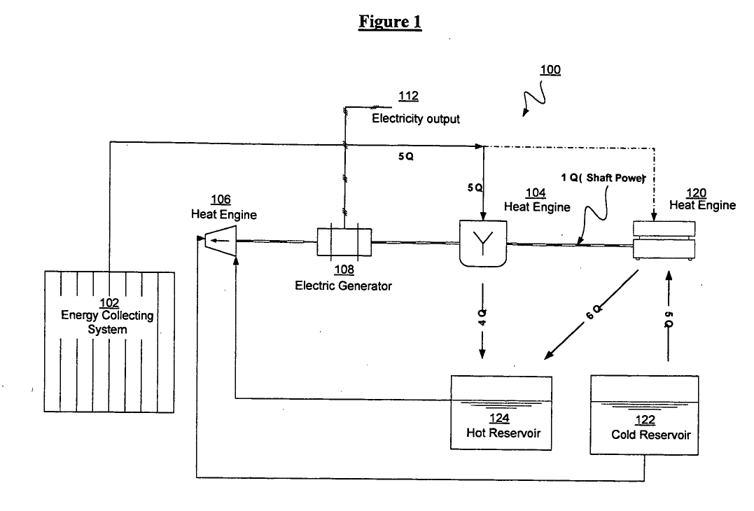

FIG. 1 depicts one variation of Power Generation System 100. In order to provide a more thorough understanding of the apparatus and methods described herein, FIG. 1 and the following description sets forth numerous specific details and calculations, such as specific equipment, assumptions, examples, and the like. It should be recognized, however, that such descriptions and calculations are not intended as a limitation on the scope of the apparatus and methods described herein, but are intended to provide a better understanding of the possible variations thereof.

### Heat Storage

Referring to FIG. 1, the system has an Energy Collecting System 102 (alternatively known as “Energy Harvesting System” in FIG. 1) such as a solar thermal energy collector that heats a fluid to generate a heated fluid to power a first heat engine 104 (e.g. a steam turbine), a second heat engine 120 (e.g. a heat pump), or both. The energy collecting system may provide heated fluid such as steam directly to one or both of heat engine 104 and heat engine 120, or some of the heat provided by the heated fluid may be used by other process steps (not illustrated in FIG. 1 for sake of figure clarity) before the heated fluid (still as steam or other gas) flows to the first heat engine 104 and/or second heat engine 120. Heat engine 104 may for example comprise one or more Rankine cycle turbines driven by e.g. steam or another heated fluid generated by or ultimately being heated by fluid from the Energy Collecting System 102. Heat engine 104 may generate electricity 112 by driving electric generator 108. Alternatively or additionally, heat engine 104 may generate heat by coupling the first heat engine 104 to second heat engine 120 (which in this instance is illustrated as a heat pump), which withdraws heat from a cold fluid in cold reservoir 122 and discharges that heat and additional heat due to the work imparted by heat engine 104 into the fluid contained in hot reservoir 124. The hot fluid discharged by first heat engine 104 may optionally be used to heat the hot Storage Fluid in Hot Reservoir 124.

### Stored Heat Utilization

The storage fluid in hot reservoir 124 has a substantially higher temperature than the storage fluid in cold reservoir 122, and this temperature difference may permit a greater amount of useful energy to be converted to electricity or other work in a third heat engine 106 than if the energy is used only to heat the hot storage fluid of hot reservoir 124. As discussed above and as depicted in FIG. 1, the first heat engine 104 may be coupled mechanically to the second heat engine 120 to extract heat from the fluid in cold reservoir 122 and transfer that extracted heat to the storage fluid in hot reservoir 124 during a heat storage operation. This procedure can in some instances transfer more heat than if the hot fluid discharged from the first heat engine 104 is used to heat only the storage fluid of the hot reservoir 124.

As can be seen from FIG. 1, the storage fluid from the hot reservoir 124 is used to heat a working fluid of a third heat engine 106 such as an organic working fluid of an organic Rankine turbine. The organic working fluid expands through the turbine, and heat is removed from the organic working fluid using the storage fluid of cold reservoir 122. The large temperature difference between the hot and cold storage fluids permits more work to be performed by the third heat engine 106 and therefore more electricity to be produced by electric generator 108 to which the third heat engine 106 may be coupled than where the heated fluid from turbine 104 is used solely to heat the storage of the hot reservoir 124.

Various components of the system discussed above are described next, and calculations on energy utilization and efficiency follow that discussion.

### Components of the System

In some variations Energy Collecting System 102 can comprise a linear Fresnel reflector (LFR) solar field. In one non-limiting example, a linear Fresnel reflector solar field can use rows of long, narrow, shallow-curvature or flat mirrors to focus light onto one or more linear receivers positioned above the mirrors. An elevated linear receiver can comprise one or more solar absorber tubes or pipes containing a working fluid, e.g. water and/or steam. In some variations, an elevated receiver can comprise a mirror (e.g. a parabolic mirror) positioned above the solar absorber tubes to further focus light in the receiver. In some variations, the system shares an elevated receiver between several rows of mirrors, while still using the simple line-focus geometry with one axis of rotation for tracking. The receiver is typically stationary. A linear Fresnel reflector solar field can include many rows of ganged mirrors in parallel over an area of land. A linear Fresnel reflector solar field may produce superheated steam or saturated steam. Examples of linear Fresnel reflector solar fields are disclosed in U.S. Application Publication Number 20060144393A1, U.S. patent application Ser. No. 12/012,920, U.S. patent application Ser. No. 12/012,829, and U.S. patent application Ser. No. 12/012,821, the entire contents each of which are incorporated by reference herein as if put forth in full below. For example, the linear Fresnel reflector solar field can comprise parallel rows of ganged reflectors having mirrors supported on a superstructure which is itself supported, e.g. by end hoops that contact wheel rollers. A motor and drive (e.g. a chain drive) pivot the ganged reflectors about an axis of rotation for the ganged reflectors so that light reflected by the mirrors contact a receiver suspended above the parallel rows of ganged reflectors. Water, steam or another working fluid such as oil or a synthetic heat transfer fluid flows through one or more solar absorber pipes within the receiver, and heated working fluid (e.g. saturated steam) emerges from a discharge end of the receiver. Additional assemblies of ganged rows of reflectors and associated elevated receivers may be provided in parallel or in series with the discharge end of the receiver to produce sufficient amounts heated working fluid. If water/steam is used as the working fluid, system can be arranged to produce a desired quality of steam, including superheated steam.

In some variations, Energy Collecting System 102 can include a parabolic trough solar field. In one non-limiting example, parabolically-shaped mirrors can be used to reflect solar radiation onto a receiver or collector above the trough. A parabolic trough system can include rows of ganged troughs arranged in parallel over an area of land. A parabolic trough system typically heats a working fluid such as an oil to high temperature and produces steam by transferring heat from the working fluid into water via a heat exchanger to produce superheated or saturated steam. One such system is disclosed in U.S. Pat. No. 7,395,820, which is incorporated by reference in its entirety as if provided in full below.

In some variations, Energy Collecting System 102 can include a dish system solar field. In one non-limiting example, a dish system can include one or more large, reflective, parabolic dishes that focus sunlight that strikes a dish onto to a receiver, which captures the heat and transfers it to a fluid. One such system is disclosed in U.S. Application Publication No. US20060179840A1, which is incorporated by reference in its entirety as if provided in full below.

In some variations, Energy Collecting System 102 can include a central tower solar field. In one non-limiting example, a central tower system can include an array of heliostats or flat, moveable mirrors to focus sunlight upon a receiver in the collector tower. One such system is disclosed in U.S. Application Publication No. US20080236568A1, which is incorporated by reference in its entirety as if provided in full below.

Energy Collecting System 102 could instead or in addition comprise a nuclear, biomass, wind, fossil fuel, geothermal, electric, or any other type of energy collecting system, including without limitation, a waste or low grade heat collection system.

All of the heat sources discussed above produce process streams such as heated steam or heated organic fluid that can be used to power the first heat engine 104 and/or the second heat engine 120. In some variations, a heat transfer fluid can include saturated or superheated steam, synthetic oil, molten salt, or other heat transfer fluid. In any of the variations described herein, the heat transfer fluid can be heated directly by the energy collecting system 102, or can be heated through heat exchange.

In one instance, as indicated by the dashed line in FIG. 1, the heat transfer fluid generated by the energy collection system 102 is in fluid communication with the second heat engine 120. The second heat engine 120 may comprise a chiller, such as a direct steam driven absorption chiller. A chiller will typically have a compressor configured to use energy from the heat transfer fluid from the system 102 to compress a working fluid that is used to cool a process stream, such as storage fluid from cold reservoir 122. Heat absorbed by the working fluid of the chiller as well as excess heat from the heat transfer fluid from the system 102 may be used to heat another process stream, such as storage fluid from hot reservoir 124.

Alternatively or in addition, the heat transfer fluid from the energy collection system 102 is in fluid communication with the first heat engine 104, which in some instances may comprise a turbine (e.g. a steam turbine). As noted above, first heat engine 104 may drive an electric generator 108 and/or the second heat engine 120. Second heat engine 120 may therefore comprise a heat pump, in which, for instance, mechanical energy from the first heat engine 104 drives a compressor configured to use energy from the heat transfer fluid to compress a working fluid that is used to cool a process stream, such as storage fluid from cold reservoir 122. Heat absorbed by the working fluid of the heat pump may be used to heat another process stream, such as storage fluid from hot reservoir 124.

If heat engine 120 is configured as a heat pump, the heat pump may, for instance, have a compressor coupled to heat engine 104, a condenser, an expansion valve, an evaporator, and a pump. In some variations, heat engine 120 can be engine- or motor-driven and may therefore receive electrical energy, e.g. from electric generator 108.

Heat engine 120 (e.g. a chiller or heat pump) may therefore be mechanically or electrically driven and may operate on acoustic, absorption, or any other design principle that enables the creation of a cold and hot temperature reservoir.

In some variations, a portion of the heat transfer fluid is in fluid communication with first heat engine 104 and a portion of the heat transfer fluid is in fluid communication with second heat engine 120.

Heat engine 104 may include any heat engine, e.g. in which heat is converted to shaft power. Heat engine 104 may include a turbine or a Stirling cycle engine, for instance. In some variations, heat engine 104 can include a saturated steam turbine. In some variations, heat engine 104 can include one or more organic Rankine turbine systems.

In some variations, all of the mechanical energy from heat engine 104 drives Electric Generator 108. In some variations, all of the mechanical energy from heat engine 104 drives second heat engine 120 (e.g. heat pump) to be stored as heat. In some variations, a portion of the energy from heat engine 104 is directed to Electric Generator 108, and a portion of the energy from heat engine 104 is directed to Heat engine 120. Heat engine 104 may comprise a turbine that, in turn, comprises a rotating shaft, the engagement of which may be controlled with one or more clutches coupled to a shaft that couples Heat engine 120 and heat engine 104 and/or to a shaft that couples Electric Generator 108 and heat engine 104.

Electric Generator 108 can be any device suitable to convert power, including, but not limited to, shaft power, into electricity. Electric Generator 108 may be coupled to an electric grid that, in some variations along with other electric generators of other power plants, supplies power to remote locations.

Methods and systems described herein may take advantage of the fact that many chiller and heat pump designs have coefficients of performance (COP) greater than one. A COP greater than one indicates that for every kWh unit used to power the chiller, the chiller delivers more than one kWh of cooling. Energy conservation requires the chiller to reject the sum of the input energy into the chiller and the removed heat, creating a “multiplier” effect to the amount of heat transferred. In some variations, if a sufficiently large cold reservoir and hot reservoir are used to store both the cold and hot sink potential from the chiller, high grade energy can be converted into low grade energy without significant loss of entropy.

Hot Reservoir 124 and Cold Reservoir 122 may include any storage fluid or fluids that may be used in the methods and systems described herein. In some variations, the storage fluid can include water. In some variations, the storage fluid can include steam, synthetic oil, molten salt, or other heat storage fluid. In some instances, the storage fluid is not molten salt or synthetic oil. In some instances, the storage fluid is a liquid and is not predominantly a gas (although the liquid may contain some dissolved or accompanying gas). Water is one preferred storage fluid, and optionally the water contains one or more additives. Water used as the storage fluid for the cold reservoir may comprise one or more additives to lower the freezing point, e.g. an antifreeze such as ethylene glycol, an alcohol, a salt, or any compound now known or later discovered to lower the freezing point. In some variations, the freezing point of the storage fluid for the cold reservoir is approximately −20 to −30° C., for instance. The storage fluid of the cold reservoir may, in some instances, freeze when heat is removed from the storage fluid by heat engine 120. The cold fluid may be maintained below the condensation temperature of the working fluid of the third heat engine (e.g. below the condensation temperature of an organic working fluid used in an organic Rankine cycle turbine) to provide improved efficiency if desired. The storage fluid of the hot reservoir may, in some instances, boil when heat is added to the storage fluid by second heat engine 120 and/or first heat engine 104. Or, the storage fluid of the hot reservoir may not boil but remain as a liquid when heat is added to it by heat engine 120 and/or first heat engine 104.

In some variations, Hot Reservoir 124 and Cold Reservoir 122 can comprise one or more insulated fluid storage tanks at about atmospheric pressure, especially if the storage fluids consist in large part of water and do not undergo a liquid to gas phase change. In some variations, Hot Reservoir 124 and Cold Reservoir 122 can be one or more insulated storage fluid storage tanks, at pressures above 1 atm. In some variations, Hot Reservoir 124 and Cold Reservoir 122 can be one or more insulated storage fluid storage tanks having a storage volume between about 1,000 to about 10,000,000,000 gallons. In some variations, Hot Reservoir 124 and/or Cold Reservoir 122 can comprise one or more insulated storage fluid storage tanks having a storage volume of about 1,000,000, 80,000, 60,000, 50,000, 40,000, 30,000, 20,000, 15,000, 10,000 or 5,000 gallons. Hot and cold reservoirs may have similar storage volumes, or different storage volumes, as described herein. For example, in some variations, the storage volume of a hot reservoir may be approximately twice that of a cold reservoir. Reservoirs may instead comprise e.g. a pond or underground cavern that retains a storage fluid. A reservoir may function at atmospheric pressure or close to atmospheric pressure. A reservoir may be sealed and insulated, but the reservoir may be provided with a vent and any vapor control system desired to control emissions of hot and/or cold storage fluid vapor.

The economics of energy storage may improve as more storage capacity is added. In some variations, a storage vessel with eight times the volume may cost about half as much per unit volume, and may experience about half the radiant and convective losses per unit volume. By extension, a vessel that is 27 times larger may cost about 1/9 as much per unit volume and may experience about 1/9 the radiant and convective losses. In some variations, the storage volume of Cold Reservoir 122 can be about one half the storage volume of Hot Reservoir 124.

In some variations, Hot Reservoir 124 and Cold Reservoir 122 can contain one or more baffles (e.g. horizontal baffles) that create zones within the reservoirs that are somewhat thermally isolated from one another although they are in fluid communication with one another. Baffles can aid in separating hotter liquid from cooler liquid, so that thermal contamination of cooler storage fluid at the bottom of the tank by hotter storage fluid entering the tank is reduced or eliminated. In some variations, Hot Reservoir 124 can include more than one tank to separate storage fluids of varying temperatures. In some variations, Cold Reservoir 122 can include more than one tank to separate storage fluids of varying temperatures. Thermal contamination, if it were to occur, could lower efficiency of the condensing process in heat engine 106 and/or of the refrigeration cycle effected by heat engine 120.

In some variations, Hot Reservoir 124 contains storage fluid at a temperature between about 80° C. and about 100° C. In some variations, Hot Reservoir 124 contains storage fluid at a temperature between about 70° C. and about 100° C. In some variations, Hot Reservoir 124 contains storage fluid at a temperature between about 60° C. and about 120° C. In some variations, Hot Reservoir 124 can be pressurized above 1 atm. In some variations, the storage fluid of Hot Reservoir 124 is in fluid communication with a Heat Engine 120, e.g. a condenser of a heat pump. In some variations, the storage fluid of Hot Reservoir 124 is in fluid communication with heat engine 104. In some variations, the storage fluid of Hot Reservoir 124 is in fluid communication with Heat Engine 106.

In some variations, Cold Reservoir 122 contains storage fluid at a temperature between about −10° C. and about 10° C. In some variations, Cold Reservoir 122 contains storage fluid at a temperature between about −20° C. and about 20° C. In some variations, Cold Reservoir 122 contains storage fluid at a temperature between about −30° C. and about 30° C. In some variations, the storage fluid in Cold Reservoir 122 may be partially in the form of ice. In some variations, the storage fluid of Cold Reservoir 122 can include an additive such as an antifreeze, an alcohol, a salt, or other suitable compound to reduce the freezing point of the storage fluid. In some variations, the storage fluid of Cold Reservoir 122 is in fluid communication with heat engine 120 (e.g. an evaporator of a Heat Pump). In some variations, the storage fluid of Cold Reservoir 122 is in fluid communication with Heat Engine 106.

In some variations, Heat Engine 106 can be any low temperature heat engine, such as an organic Rankine cycle turbine. Organic working fluids are useful in place of water/steam when low-grade thermal energy is encountered. The heat engine 106 may be configured to operate in a working cycle other than a Rankine work cycle, such as a Carnot cycle, Ericsson cycle, Stirling or pseudo-Stirling cycle, Kalina cycle, and may be e.g. a Stoddard engine, if desired.

To keep the system size small and efficiency high, organic working fluids with boiling points near room temperature may be employed in heat engine 106. Such fluids have higher gas densities when operating near their boiling points, allowing for higher capacity and favorable transport and heat transfer properties and enabling higher efficiency as compared to other working fluids, e.g. water. In some variations, the organic working fluid can include toluene, pentane, butane, isobutane, propane, and/or hexane.

The working fluid of the low temperature heat engine (e.g. an organic working fluid of an organic Rankine cycle turbine) therefore may have a boiling point at atmospheric pressure within about 15 to about 120° C. of the temperature of the storage fluid from the hot reservoir. The temperature difference between the two fluids (the working fluid of heat engine 106 and the storage fluid from the hot reservoir 124) may therefore be within about 15, 20, 25, 30, 35, 40, 45, 50, 55, 60, 65, 70, 75, 80, 85, 90, 95, 100, 105, 110, 115, or 120° C. of one another. The storage fluid of the hot reservoir may therefore have a boiling point that is no more than about 15 to about 120° C. greater than the boiling point of the working fluid for heat engine 106 (e.g. organic working fluid) at atmospheric pressure. The difference in boiling points between the two fluids (the working fluid of heat engine 106 and storage fluid from the hot reservoir 124) may therefore be within about 15, 20, 25, 30, 35, 40, 45, 50, 55, 60, 65, 70, 75, 80, 85, 90, 95, 100, 105, 110, 115, or 120° C. at atmospheric pressure.

The working fluid of heat engine 106 (e.g. an organic working fluid of an organic Rankine cycle turbine) may additionally or instead have a boiling point at atmospheric pressure within about 15 to about 120° C. of the temperature of the storage fluid from the cold reservoir. The temperature difference between the two fluids (the working fluid of heat engine 106 and the storage fluid from cold reservoir 122) may therefore be within about 15, 20, 25, 30, 35, 40, 45, 50, 55, 60, 65, 70, 75, 80, 85, 90, 95, 100, 105, 110, 115, or 120° C. of one another. The storage fluid of the cold reservoir may therefore have a boiling point that is no more than about 15 to about 120° C. greater than the boiling point of the working fluid for heat engine 106 (e.g. organic working fluid) at atmospheric pressure. The difference in boiling points between the two fluids (the working fluid of heat engine 106 and the storage fluid from cold reservoir 122) may therefore be within about 15, 20, 25, 30, 35, 40, 45, 50, 55, 60, 65, 70, 75, 80, 85, 90, 95, 100, 105, 110, 115, or 120° C. at atmospheric pressure.

As noted previously, energy in the form of heat is supplied to heat engine 106 by storage fluid from Hot Reservoir 124, where a heat exchanger (not shown) transfers energy from the storage fluid of Hot Reservoir 124 into the working fluid for heat engine 106. If the working fluid for heat engine 106 is organic, the organic working fluid vaporizes and builds pressure due to the added heat, and the organic working fluid is routed to Heat Engine 106 to perform work. In some variations, the organic working fluid is cooled at the discharge end of Heat Engine 106 by storage fluid from cold reservoir 122 and condenses. The condensed liquid organic working fluid may then be pumped back to contact additional storage fluid from hot reservoir 124 to continue driving heat engine 106.

In one instance, heat engine 106 is configured as an organic Rankine cycle turbine that is, in turn, configured so that the organic working fluid remains a vapor as the organic working fluid leaves the discharge end of the turbine. This configuration avoids placing the discharge end of the turbine under vacuum, which can in some variations affect turbine efficiency adversely. The organic working fluid may subsequently be condensed using storage fluid from the cold reservoir 122, if desired.

In some variations, the first heat engine 104 comprises a turbine (e.g. a steam turbine and one that optionally operates as a condensing steam turbine), the second heat engine 120 comprises a heat pump coupled mechanically to the turbine 104, the third heat engine 106 comprises an organic Rankine cycle engine employing an organic working fluid (such as hexane, butane, isobutane, pentane, and/or toluene) with a boiling point of approximately atmospheric temperature (e.g. near or below about 70° C.), and the storage fluids in both the hot reservoir 124 and cold reservoir 122 are aqueous and are stored at atmospheric pressure. The energy collecting system 102 of power generating system 100 may be a linear Fresnel array as discussed above, which in some instances may further economy and efficiency of system 100, and especially a linear Fresnel array that produces saturated steam. Condensate from heat engine 104 or heat from the condensate may be transferred to hot reservoir 124.

The use of solar thermal energy to chill a storage fluid to below ambient temperature and also heat a storage fluid to above ambient temperature can help limit heat losses by avoiding large temperature extremes from ambient temperature. This can help improve efficiency for the system while it operates.

Capital cost is one consideration in designing a facility. The ability to improve thermodynamic efficiency as discussed above may also be coupled with the ability to limit capital expenditures for a facility. The storage fluids in both the cold reservoir and the hot reservoir may be stored at atmospheric pressure. Further the temperatures of the storage fluids in the hot and cold reservoirs are not especially high or low. This reduces capital cost for the facility, since specially-designed pressure vessels are not needed.

There are numerous strategies that can be implemented in deciding when and for how long energy should be stored. In one variation, a price arbitrage strategy could be adopted in which energy is stored during times of relatively low electricity prices and converted into electricity during times of relatively high electricity prices, such as during business hours. In one variation of such a strategy, the relative price of electricity over time would act, at least in part, as a driver in the optimization of profit. In some variations, a seasonal storage strategy could be adopted. Another non-limiting example would be to store a portion of the energy harvested in the spring to later convert in the summer. Overall plant economics can improve with addition of thermal storage capacity in the hot reservoir and the cold reservoir. Further, thermal energy may be stored in order to help balance the power grid and to supply additional electrical power to supplement capacity or intentional or unintentional reductions in output from a power generating plant.

In one non-limiting example, assume that the price of wholesale electricity varies between $X per MWh and $Y per MWh, where X<Y. When electricity is priced at about $X per MWh, a portion, or all, of the energy harvested will be stored. In particular, a portion, or all, the energy outputted from heat engine 104 will be directed to Heat engine 120 to be stored as thermal energy. When electricity is priced at about $Y per MWh, all or essentially all of the energy harvested will be converted to electricity. Moreover, the stored thermal energy will also be converted to electricity. In particular, a portion, or all, the energy outputted from heat engine 104 will be directed to Electric Generator 108 and stored thermal energy will be converted to electricity with Heat Engine 106. Continuing with the foregoing example, assume a given plant harvested energy that would result in 100 MWh during a period where electricity was priced at $100 per MWh and the plant also harvested energy that would result in 100 MWh during a period where electricity was priced at $X per MWh. Without a storage strategy as described herein, the plant could generate about $ (X+Y)*100 in revenue (100 MWh*$X/MWh+100 MWh*$Y/MWh). However, assuming a storage loss percentage L (e.g. about 25%), if the storage strategy described herein is implemented, the plant could generate approximately $ (2*(Y−L)*100) (100 MWh*$Y/MWh+100 MWh*(1−L)*$Y/MWh) for about an increase in revenue that depends on the difference between Y and X and the loss percentage L.

Other factors involved in the optimization could include the amount of storage capacity and the fixed storage equipment costs.

In some variations, an energy reliability strategy could be adopted. In one variation of such a strategy, the reliability of electricity output would, at least in part, drive the optimization of the reservoir sizing. The larger the energy storage capacity, the longer the entire energy collecting system could “go down,” or be without energy to harvest, without interruption of electricity output. For example, assume that a plant harvests energy with a solar field. There are an array of events that could interrupt the generation of electricity including, but not limited to, plant maintenance, equipment failure, cloud cover, night time, and the like. A sufficient amount of thermal energy could be stored and converted as discussed above.

In some variations, an oversized energy collecting system (or undersized turbine) strategy could be adopted. One non-limiting example of this strategy would be to design the main turbine-generator system of the power generation system with less capacity (generally less expensive) and store the surplus harvested energy that cannot be converted by the main turbine-generator. at peak energy harvest periods to be utilized at lower energy harvest periods. In some variations, the harvested energy is about twice the amount that the main turbine-generator system can utilize at a given time. In some variations, the harvested energy is about three times the amount that the main turbine-generator system can utilize at a given time. In some variations, the harvested energy is about five times the amount that the main turbine-generator system can utilize at a given time. In some variations, the harvested energy is about ten times the amount that the main turbine-generator system can utilize at a given time.

In some variations, any combination of any of the above strategies could be adopted or combined with any other energy storage strategy.

In order to provide a more thorough understanding of the apparatus and methods described herein, the following calculations set forth numerous specific details and assumptions, such as specific equipment, temperatures, examples, and the like. It should be recognized, however, that such assumptions and calculations are not intended as a limitation on the scope of the apparatus and methods described herein, but are intended to provide a better understanding thereof.

Referring again to FIG. 1, as a non-limiting example, assume that the sun is at an elevation position such that precisely the amount of energy required to power the steam turbine at its nameplate rating of 180 MW, is available to the solar field. Or, in other words, there is no surplus energy. As discussed above, some solar plants generate surplus energy, i.e., more than can be converted by the turbine-generator, during a portion of the day. In addition, it is assumed that the plant operator has controlled the power plant to send all output from the steam turbine into thermal storage, instead of through the electrical generator and out to the grid. For this example, let the energy collected by the solar field at this instant in time be equal to the amount 5 Q.

Modern chillers and heat pumps have an overall coefficient of performance (COP) between about 0.7 and about 6, between about 1.3 and about 6, or between about 2 and about 6. The COP is the ratio of energy removed divided by energy input=Q1/Q2, where Q1=the energy removed from the cold temperature reservoir, and Q2=the electrical or mechanical energy provided to the chiller or heat pump to drive it. Modern electric motor driven chillers may have COPs that range from about 2 to about 6, and direct steam absorption units may have COPs that range from about 0.7 to about 1.4.

Energy Conservation requires that: Q1+Q2=Q3, where Q3 is the energy that is rejected from the chiller or heat pump. For a COP of 5, then, the heat balance is: 5 kWh+1 kWh=6 kWh.

Referring again to FIG. 1, heat engine 104 may comprise a turbine, e.g. a saturated steam turbine that has a 100° C. temperature of condensation. At this temperature, the overall conversion efficiency of saturated steam with an inlet temperature of 270° C. is about 22%. This results in available shaft power of about 1 Q, which can be either routed to the electric generator 106 or to a compressor in heat engine 120. As shown, the heat rejected from the steam turbine 104 in this example is equal to about 4 Q.

The cooling fluid for the saturated steam turbine is provided by the hot water reservoir 124, which can be water at about 80° C., still hot from the previous day's storage. The cooling water absorbs the heat of condensation in an indirect heat exchanger in the steam turbine condenser, rises to a temperature of 100° C., and is routed back to the hot water reservoir 124. The energy absorbed by the cooling fluid is therefore equal to about 4 Q.

If the plant is in storage mode, all shaft power from the steam turbine 104 is directed to a refrigerant compressor in heat engine 120.

Continuing with the foregoing example, inside the compressor, a gas refrigerant in heat engine 120 is compressed due to the work performed by the shaft power. Assume a refrigerant gas inlet temperature of 0° C. Due to the change in internal energy due to the work of compression, the gas increases in temperature to well above about 100° C. at the exit, for example to about 150° C.

The compressed gaseous refrigerant is sent to the refrigerant system condenser in heat pump 120, where it is cooled. Like the steam turbine 104, the cooling fluid in the condenser is provided by the hot water reservoir 124 in the form of water at about 80° C. In some variations, the refrigerant condenses and delivers its heat of condensation to the cooling water, elevating it to a temperature of about 100° C. Since the overall refrigeration system COP is assumed to be 5, conservation requires that 6 Q units of heat energy are delivered to the hot water tank 124.

After condensation, in some variations, the 100° C. liquid refrigerant in heat engine 120 passes through an expansion valve, where the refrigerant is throttled to a lower pressure. The liquid flash boils, and a portion of the liquid converts to vapor. The throttling pressure may drop the temperature of the two phase refrigerant to about −20° C. The two phase refrigerant passes to the evaporator. In the evaporator, the liquid refrigerant draws heat energy from the cold water reservoir, and the balance of the liquid is converted to vapor. With a COP of 5, an amount equal to 5 Q units of heat energy is drawn from the cold reservoir 122. In this example, the temperature of the water pumped from the cold reservoir decreases from about 10° C. to about −10° C. in the exchange.

Continuing with the foregoing example, hot water in the hot water reservoir 124 starts the day at about 80° C., still hot from the previous day's operation. As the day progresses, water is removed from the tank, heated, and returned to the tank at about 99° C.

The energy storage capacity of the reservoir may be calculated as follows. For e.g. a 180 MW plant, in one variation, a reasonable estimate of required storage potential for use during e.g. cloudy weather is two hours, or 360 MWh. Assuming about a 10% Organic Rankine cycle efficiency in the conversion process results in 3,600 MWh of thermal energy storage, or 1.3×10E10 kJ. Assuming that heat storage is accomplished by elevating water from a temperature of 80° C. to 99° C., the volume j of the storage tank is thus determined by the following (where Cp is the heat capacity of water):

Q=j·Cp·(T2−T1) 1.3×10E10 kJ=j·(4.2 kJ/kG/° C.)(19° C.) j=154,000,000 (liters) Volume=41,000,000 gallons

Continuing with the foregoing example, the cold reservoir could be a similarly large insulated water tank, but in some variations only needs to supply have the storage volume as large as the hot water tank.

The organic Rankine cycle turbine of the foregoing example may have a shell and tube heat exchanger that transfers energy from water at about 99° C. from the hot reservoir and into the working fluid of the organic Rankine cycle turbine. The working fluid vaporizes and builds pressure due to the added heat and is routed to the turbine to do work. In some variations, the working fluid condenses at approximately 20° C. at the discharge end of the organic Rankine turbine, where the working fluid is pumped in liquid form back to the evaporator.

An organic Rankine cycle turbine may deliver an overall thermodynamic cycle efficiency of around 11% with an overall temperature differential in the range of about 100° C. Any suitable organic Rankine cycle turbine may be used, e.g. one from Ormat. Organic Rankine cycle turbines in some cases are low maintenance and have higher availabilities and fewer unplanned outages than steam turbines and are therefore may be quite useful as heat engines 106 in the system and methods disclosed herein. One example of an organic Rankine cycle turbine is disclosed in U.S. Pat. No. 7,096,665, the contents of which are incorporated by reference herein as if put forth in full below. In this system, propane or other light hydrocarbon fluid is vaporized in multiple indirect heat exchangers using storage fluid from the hot reservoir. The pressurized propane gas expands in multiple cascading turbines and rotates a shaft connected to electric generator 108.

Continuing with the foregoing example, for every hour of storage—180 MWh—the volume utilized from the tank is 21,000,000 gallons, or 79×10⁶ liters (kg).

Continuing with the foregoing example, to estimate pumping losses, an assumption is made about the pressure drop through the heat exchanger that will transfer energy from the hot water to the working fluid that powers the organic Rankine turbine. The pressure drop for a shell and tube heat exchanger is estimated to be about 50 feet of water, or about 150 kPa. The flow rate would therefore be about 350,000 gpm (21.2 m³/s) (21M gallons divided by 60 minutes). The power required to overcome the pressure drop is given as: Volume Flow·Pressure Drop=(21.2 m³/s)·(150 kPa)=3180 kW. This results in a pumping parasitic load of about 3.2 MW to provide the heating water to the 180 MW organic Rankine turbine heat exchanger when it is at full output, or about 2%. Pumps in the 160,000 gpm size range are available, e.g. from FPI, Inc., www.fpipumps.com/new/pdf/1/largvolpumpbro1.pdf.

Continuing with the foregoing example, it is useful to compare how much electricity would be created from the solar field if the steam were routed to the standard saturated steam turbine rather than to a system as described herein to evaluate efficiency improvement For this calculation, the amount of energy available for conversion is assumed to be 5 Q.

The saturated steam turbine, using dry cooling, converts the thermal energy (5 Q) to electrical energy at an efficiency of about 26%. The amount of electrical energy created using the saturated steam turbine is therefore equal to 5 Q×0.26. For comparison purposes, assume that 5 Q is the change of enthalpy as the steam performs work in the turbine. The inlet condition is 250° C. and the outlet condition is 50° C., saturated. The change in enthalpy between these two states is 2591 kJ/kg, which is equal to 5 Q. Thus, the energy per kg that is converted into shaft power is 2591×0.26, or 674 kJ.

In this example, if the 5 Q input energy is all routed through the storage system, the following analysis applies. A Second Law of Thermodynamics analysis allows for 57 kg of cold water at 0° C. and 115 kg of hot water at 100° C. to result from the process.

By applying an overall organic Rankine cycle efficiency of about 11% for water converted with a temperature differential of 100° C., and about 6% for water converted with a temperature differential of 50° C., this final conversion can be achieved as follows:

56.5 kg@11% Work=efficiency·Mass·Cp·(T2−T1) Work=0.11·(56.5 kg)·(4.2 kJ/kg/C)·(19° C.) Work (energy)=495 kJ 56.5 kg@6% Work=efficiency·Mass·Cp·(T2−T1) Work=0.06·(56.5 kg)·(4.2 kJ/kg/C)·(19C) Work (energy)=270 kJ Total work performed is 495+270=765 kJ

Continuing with the foregoing example, more energy may be converted into shaft power using systems and methods as described herein when compared to the base case of using all steam generated by the solar energy collecting system 102 to drive steam turbine 104. The ratio of shaft power from the systems and methods described herein compared to the conventional method indicates efficiency increases, e.g. efficiency increases of about 14% (674 kJ vs. 765 kJ as shown above). Thus, as this example shows, the overall conversion process can be more efficient.

A solar thermal energy field and/or some or all of the first, second, and third heat engines and hot and cold reservoirs may be added to an existing power plant. The systems described herein may be configured as a retrofit to add thermal energy storage capacity to an existing power plant, e.g. to improve overall efficiency for the existing power plant and/or more consistent electricity supply from the power plant.

A system as discussed herein may produce at least about ½, 1, 2, 5, 10, 20, or 50 megawatts electricity. This electrical generation capacity may be retrofitted as discussed above, or this capacity may be incorporated into the design of a new power plant.

Those skilled in the art will recognize that the operations of some variations may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the apparatus and methods described herein.

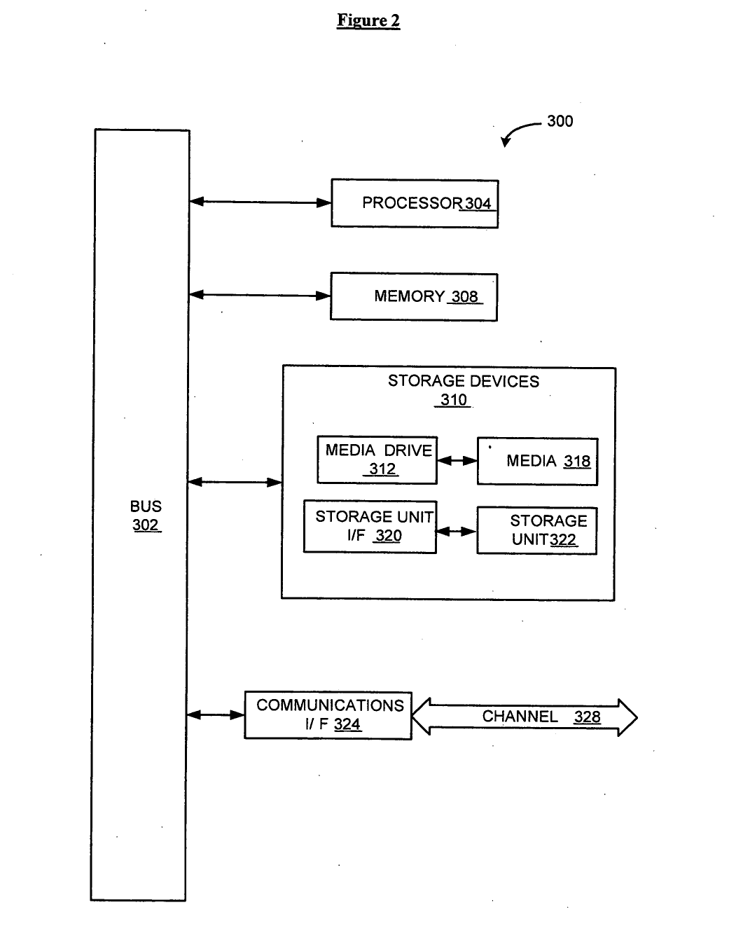

FIG. 2 illustrates a typical computing system 300 that may be employed to carry out processing functionality in some variations of the process. Those skilled in the relevant art will also recognize how to implement the apparatus and methods described herein using other computer systems or architectures. Computing system 300 may represent, for example, a desktop, laptop, or notebook computer, hand-held computing device (PDA, cell phone, palmtop, etc.), mainframe, supercomputer, server, client, or any other type of special or general purpose computing device as may be desirable or appropriate for a given application or environment. Computing system 300 can include one or more processors, such as a processor 304. Processor 304 can be implemented using a general or special purpose processing engine such as, for example, a microprocessor, controller or other control logic. In this example, processor 304 is connected to a bus 302 or other communication medium.

Computing system 300 can also include a main memory 308, preferably random access memory (RAM) or other dynamic memory, for storing information and instructions to be executed by processor 304. Main memory 308 also may be used for storing temporary variables or other intermediate information during execution of instructions to be executed by processor 304. Computing system 300 may likewise include a read only memory (“ROM”) or other static storage device coupled to bus 302 for storing static information and instructions for processor 304.

The computing system 300 may also include information storage mechanism 310, which may include, for example, a media drive 312 and a removable storage interface 320. The media drive 312 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 318, may include, for example, a hard disk, floppy disk, magnetic tape, optical disk, CD or DVD, or other fixed or removable medium that is read by and written to media drive 312. As these examples illustrate, the storage media 318 may include a computer-readable storage medium having stored therein particular computer software or data.

In some variations, information storage mechanism 310 may include other similar instrumentalities for allowing computer programs or other instructions or data to be loaded into computing system 300. Such instrumentalities may include, for example, a removable storage unit 322 and an interface 320, such as a program cartridge and cartridge interface, a removable memory (for example, a flash memory or other removable memory module) and memory slot, and other removable storage units 322 and interfaces 320 that allow software and data to be transferred from the removable storage unit 322 to computing system 300.

In some variations, computing system 300 can also include a communications interface 324. Communications interface 324 can be used to allow software and data to be transferred between computing system 300 and external devices. Non-limiting examples of communications interface 324 can include a modem, a network interface (such as an Ethernet or other NIC card), a communications port (such as for example, a USB port), a PCMCIA slot and card, etc. Software and data transferred via communications interface 324 are in the form of signals which can be electronic, electromagnetic, optical or other signals capable of being received by communications interface 324. These signals are provided to communications interface 324 via a channel 328. This channel 328 may carry signals and may be implemented using a wireless medium, wire or cable, fiber optics, or other communications medium. Some examples of a channel include a phone line, a cellular phone link, an RF link, a network interface, a local or wide area network, and other communications channels.

The terms “computer program product” and “computer-readable storage medium” may be used generally to refer to media such as, for example, memory 308, storage device 318, storage unit 322, or signal(s) on channel 328. These and other forms of computer-readable storage media may be involved in providing one or more sequences of one or more instructions to processor 304 for execution. Such instructions, generally referred to as “computer program code” (which may be grouped in the form of computer programs or other groupings), when executed, enable the computing system 300 to perform features or functions of embodiments of the apparatus and methods described herein.

In some variations where the elements are implemented using software, the software may be stored in a computer-readable storage medium and loaded into computing system 300 using, for example, removable storage drive 312 or communications interface 324. The control logic (in this example, software instructions or computer program code), when executed by the processor 304, causes the processor 304 to perform the functions of the apparatus and methods described herein.

It will be appreciated that, for clarity purposes, the above description has described embodiments of the apparatus and methods described herein with reference to different functional units and processors. However, it will be apparent that any suitable distribution of functionality between different functional units, processors or domains may be used without detracting from the apparatus and methods described herein. For example, functionality illustrated to be performed by separate processors or controllers may be performed by the same processor or controller. Hence, references to specific functional units are only to be seen as references to suitable means for providing the described functionality, rather than as indicative of a strict logical or physical structure or organization.

Although the apparatus and methods described herein have been described in connection with some embodiments, they are not intended to be limited to the specific forms set forth herein. Rather, the scope of the apparatus and methods described herein are limited only by the claims. Additionally, although a feature may appear to be described in connection with particular embodiments, one skilled in the art would recognize that various features of the described embodiments may be combined in accordance with the apparatus and methods described herein.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Terms and phrases used in this document, and variations thereof, unless otherwise expressly stated, should be construed as open ended as opposed to limiting. As examples of the foregoing: the term “including” should be read to mean “including, without limitation” or the like; the terms “example” or “some variations” are used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the apparatus and methods described herein may be described or claimed in the singular, the plural is contemplated to be within the scope thereof unless limitation to the singular is explicitly stated. The presence of broadening words and phrases such as “one or more,” “at least,” “but not limited to,” “in some variations” or other like phrases in some instances shall not be read to mean that the narrower case is intended or required in instances where such broadening phrases may be absent.

1. A method of producing electricity comprising
(a) removing heat from a first storage fluid in a cold reservoir to produce colder first storage fluid;
(b) transferring said heat to a second storage fluid in a hot reservoir to produce hotter second storage fluid;
(c) evaporating an organic working fluid using heat from the hotter second storage fluid;
(d) using the organic working fluid to generate electricity; and
(e) cooling the organic working fluid using the colder first storage fluid.

2. A method according to claim 1 wherein the act of cooling the organic working fluid condenses the organic working fluid.

3. A method according to claim 1 wherein the act of removing the heat from the first storage fluid comprises placing the first storage fluid in heat exchange relationship with a heat transfer fluid to remove the heat from the first storage fluid, and the act of transferring the heat to the second storage fluid comprises placing the second storage fluid in heat exchange relationship with the heat transfer fluid to transfer heat from the heat transfer fluid to the second storage fluid.

4. A method according to claim 3 wherein the heat transfer fluid comprises an organic heat transfer fluid.

5. A method according to claim 1 wherein the act of evaporating the organic working fluid reduces the temperature of the hotter second storage fluid by no more than about 30° C.

6. A method according to claim 1 wherein the act of cooling the organic working fluid increases the temperature of said colder first storage fluid by no more than about 30° C.

7. A method according to claim 1 wherein the organic working fluid has a boiling point between about −1° C. and about 70° C. at standard pressure.

8. A method according to claim 7 wherein the organic working fluid comprises at least one of hexane, pentane, isobutane, and butane.

9. A method according to claim 1 wherein the first storage fluid is a first aqueous storage fluid, and the second storage fluid is a second aqueous storage fluid.

10. A method according to claim 1 and further comprising using heat from a process stream of a power plant as a source of energy to perform the act of removing said heat from the first storage fluid in the cold reservoir to produce said colder first storage fluid and to perform the act of transferring said heat to the second storage fluid in the hot reservoir to produce said hotter second storage fluid.

11. A method according to claim 10, wherein said energy performing said acts comprises mechanical energy to power a compressor which acts on the organic working fluid.

12. A method according to claim 11, wherein said process stream comprises low temperature steam which rotates a turbine to produce said mechanical energy.

13. A method according to claim 12 wherein heat from said low temperature steam, after passing through said turbine, is transferred into said second storage fluid of the hot reservoir.

14. An energy generation system, comprising
(a) a hot reservoir configured to retain a first storage fluid;
(b) a cold reservoir configured to retain a second storage fluid;
(c) a first heat engine in fluid communication with the hot reservoir and the cold reservoir, and wherein the first heat engine is configured to remove heat from the second storage fluid and transfer that heat into the first storage fluid;
(d) a second heat engine in fluid communication with the hot reservoir and the cold reservoir, the second heat engine having an organic working fluid and being configured to transfer heat from the first storage fluid into the organic working fluid and also being configured to transfer heat from the organic working fluid into the second storage fluid; and
(e) an electrical generator coupled to the second heat engine.

15. A system according to claim 14, wherein the first storage fluid has a boiling point within about 15 to about 120° C. of a boiling point of the organic working fluid at standard pressure; and wherein the second storage fluid has a boiling point within about 15 to about 120° C. of said boiling point of the organic working fluid.

16. A system according to claim 15, wherein the boiling point of the first storage fluid is within about 15 to about 60° C. of the boiling point of said organic working fluid, and wherein the boiling point of the second storage fluid is within about 15 to about 60° C. of the boiling point of said organic working fluid.

17. A system according to claim 15, wherein the organic working fluid has a boiling point between about −1° C. and about 70° C. at standard pressure.

18. A system according to claim 15, wherein the organic working fluid comprises at least one of hexane, pentane, isobutene, and butane.

19. A system according to claim 14, wherein the first storage fluid is a first aqueous storage fluid, and the second storage fluid is a second aqueous storage fluid.

20. A system according to claim 14, wherein the system further comprises a third heat engine configured to power the first heat engine.

21. A system according to claim 20, wherein the third heat engine comprises a turbine.

22. A system according to claim 21, wherein the turbine is a saturated steam turbine.

23. A system according to claim 20, wherein the turbine is mechanically coupled to the first heat engine.

24. A system according to claim 23, wherein the first heat engine comprises a heat pump.

25. A system according to claim 14, wherein the first heat engine comprises a heat pump.

26. A system according to claim 14, wherein the first heat engine comprises a chiller.

27. A system according to claim 14, wherein the second heat engine comprises an organic Rankine cycle turbine.

28. A system according to claim 20 and further comprising a solar thermal energy heat source that heats a working fluid that powers the third heat engine.

29. A system according to claim 28 wherein the solar thermal energy heat source comprises a linear Fresnel solar, array.

30. A system according to claim 29 wherein the linear Fresnel solar array is configured to generate saturated steam.

31. A system according to claim 14 wherein the hot reservoir is configured to operate at about atmospheric pressure.

32. A system according to claim 14 wherein the cold reservoir is configured to operate at about atmospheric pressure.

33. A system according to claim 14 wherein the cold reservoir comprises an insulated tank and the hot reservoir comprises an insulated tank.

34. A system according to claim 14 wherein the electrical generator produces at least 1 megawatt of electricity.

35. A method of generating electricity, comprising:
increasing the temperature of a first storage fluid in a hot reservoir and reducing the temperature of a second storage fluid in a cold reservoir with a power source; and
generating electricity with an organic Rankine cycle turbine with the hot reservoir and the cold reservoir.

36. The method of claim 35, comprising generating more than about 1 megawatt of electricity with the organic Rankine cycle with the hot reservoir and the cold reservoir.

37. The method of claim 35, wherein the power source is a solar energy collecting system.

38. The method of claim 35, wherein the hot reservoir comprises a tank with water at 1 atm and temperature between about 70° C. and about 100° C.

39. The method of claim 35, wherein the cold reservoir comprises a tank with water at 1 atm and temperature between about −20° C. and about 20° C.

40. The method of claim 35, wherein the hot water reservoir has a storage volume that is greater than about 30,000 gallons.

41. The method of claim 35, wherein the cold water reservoir has a storage volume that is greater than about 15,000 gallons.

42. A method of generating electricity, comprising:
operating a heat pump driven by a power source to store thermal energy; and
generating electricity with an organic Rankine turbine with the stored thermal energy.

43. The method of claim 42, comprising generating more than about 1 megawatt of electricity with the organic Rankine turbine with the stored thermal energy.

44. The method of claim 42, wherein the power source is a solar energy collecting system.

45. The method of claim 42, wherein the stored thermal energy is stored in a hot reservoir and a cold reservoir, wherein the hot reservoir comprises a tank with water at about 1 atm and temperature between about 80° C. and about 100° C., and wherein the cold reservoir comprises a tank with water at about 1 atm and temperature between about −10° C. and about 10° C.

46. The method of claim 45, wherein the hot water reservoir has a storage volume that is greater than about 30,000 gallons.

47. The method of claim 45, wherein the cold water reservoir has a storage volume greater than about 15,000 gallons.

48. A method of generating electricity, comprising:
operating a heat pump driven by a power source to create a hot water reservoir at about 1 atm and at a temperature between about 70° C. and about 100° C., and a cold water reservoir at about 1 atm and at a temperature between about −20° C. and about 20° C.; and
generating electricity with an organic Rankine turbine driven by the hot water reservoir and the cold water reservoir.

49. The method of claim 48, comprising generating more than about 1 megawatt of electricity with the organic Rankine turbine driven by the hot water reservoir and the cold water reservoir.

50. The method of claim 48, wherein the power source is a solar energy collecting system.

51. The method of claim 48, wherein the hot water reservoir comprise a tank with water at about 1 atm and temperature between about 80° C. and about 100° C.

52. The method of claim 48, wherein the cold water reservoir comprises a tank with water at about 1 atm and temperature between about −10° C. and about 10° C.

53. The method of claim 48, wherein the hot water reservoir has a storage volume greater than about 30,000 gallons.

54. The method of claim 48, wherein the cold water reservoir has a storage volume greater than about 15,000 gallons.

55. A method of generating electricity, comprising:
storing thermal energy during periods of relatively low electricity prices, wherein storing thermal energy comprises:
increasing the temperature of a hot reservoir and lowering the temperature of a cold reservoir with a power source to create stored thermal energy;
converting the stored thermal energy during periods of relatively high electricity prices, wherein converting the stored thermal energy comprises:
generating electricity with an organic Rankine turbine with the hot reservoir and the cold reservoir.

56. The method of claim 55, comprising generating more than about 1 megawatt of electricity with the organic Rankine turbine with the hot reservoir and the cold reservoir.

57. The method of claim 55, wherein the power source is a solar energy collecting system.

58. The method of claim 55, wherein the hot reservoir comprises a tank with water at about 1 atm and temperature between about 70° C. and about 100° C.

59. The method of claim 55, wherein the cold reservoir comprises a tank with water at about 1 atm and temperature between about −20° C. and about 20° C.

60. The method of claim 55, wherein the hot water reservoir has a storage volume greater than about 30,000 gallons.

61. The method of claim 55, wherein the cold water reservoir has a storage volume greater than about 15,000 gallons.

62. A computer-readable storage medium comprising computer-executable instructions to control electricity generation, the instructions for:
storing thermal energy during periods of relatively low electricity prices, wherein storing thermal energy comprises:
increasing the temperature of a hot reservoir and lowering the temperature of a cold reservoir with a power source to create stored thermal energy;
converting the stored thermal energy during periods of relatively high electricity prices, wherein converting the stored thermal energy comprises:
generating electricity with an organic Rankine turbine with the hot reservoir and the cold reservoir.

63. The medium of claim 62, wherein the power source is a solar energy collecting system.

64. The medium of claim 62, wherein the hot reservoir comprises a tank with water at about 1 atm and temperature between about 70° C. and about 100° C.

65. The medium of claim 62, wherein the cold reservoir comprises a tank with water at about 1 atm and temperature between about −20° C. and about 20° C.

66. The medium of claim 62, wherein the hot water reservoir has a storage volume greater than about 30,000 gallons.

67. The medium of claim 62, wherein the cold water reservoir has a storage volume greater than about 15,000 gallons.

68. A system to generate electricity, comprising:
a heat pump operable to increase the temperature of a hot reservoir and lower the temperature of a cold reservoir with a power source; and
an organic Rankine turbine, wherein the organic Rankine turbine is operable to generate electricity with energy from the hot reservoir and the cold reservoir.

69. The system of claim 68, wherein the organic Rankine turbine is operable to generate more than about 1 megawatt of electricity with energy from the hot reservoir and the cold reservoir.

70. The system of claim 68, wherein the power source is a solar energy collecting system.

71. The system of claim 68, wherein the hot reservoir comprises a tank with water at about 1 atm and temperature between about 70° C. and about 100° C.

72. The system of claim 68, wherein the cold reservoir comprises a tank with water at about 1 atm and temperature between about −20° C. and about 20° C.

73. A system to generate electricity, comprising:
a turbine to generate electricity with energy from a power source, wherein the energy from the power source is greater than a capacity of the turbine to utilize the energy;
a heat pump operable to convert energy from the power source to stored energy; and
an organic Rankine turbine, wherein the organic Rankine turbine is operable to generate electricity with the stored energy.

74. The system of claim 73, wherein the organic Rankine turbine is operable to generate electricity with the stored energy.

75. The system of claim 73, wherein the power source is a solar energy collecting system.

76. The system of claim 73, wherein the stored energy is stored in a hot reservoir and a cold reservoir, wherein the hot reservoir comprises a tank with water at about 1 atm and temperature between about 70° C. and about 100° C., and wherein the cold reservoir comprises a tank with water at about 1 atm and temperature between about −20° C. and about 20° C.

77. A system to generate electricity, comprising:
a hot water reservoir at about 1 atm and at a temperature between about 70° C. and about 100° C., and a cold water reservoir at about 1 atm and at a temperature between about −20° C. and about 20° C.;
a heat pump operable to be driven by a power source to create the hot water reservoir and the cold water reservoir; and
an organic Rankine turbine for generating electricity, wherein the turbine is operable to be driven by one or more working fluids in fluid communication with the hot water reservoir and the cold water reservoir.

78. The system of claim 77, wherein the power source is a solar energy collecting system.

79. The system of claim 77, wherein the hot water reservoir has a storage volume greater than about 30,000 gallons.

80. The system of claim 77, wherein the cold water reservoir has a storage volume greater than about 15,000 gallons.

81. The system of claim 77, wherein the hot water reservoir is at a temperature between about 80° C. and about 100° C.

82. The system of claim 77, wherein the cold water reservoir is at a temperature between about −10° C. and about 10° C.

83. A method of improving efficiency of a power plant, comprising utilizing waste heat from low temperature steam to transfer heat from a cooler liquid to a hotter liquid, using heat from the hotter liquid and chilling by the cooler liquid to power an organic Rankine cycle turbine, and generating electricity using the organic Rankine cycle turbine.

84. A method of improving efficiency of a power plant which employs one or more Rankine cycle turbines to generate electricity, comprising retrofitting to said plant a system comprising (1) a chiller or heat pump configured to utilize heat from a low temperature steam derived from said one or more Rankine cycle turbines, (2) a hot reservoir, (3) a cold reservoir, (4) an organic Rankine cycle turbine in fluid communication with the hot reservoir and the cold reservoir, and (5) an electrical generator.

85. A method according to claim 84 and further comprising retrofitting a solar energy collecting system which supplies heat to said low temperature steam.

86. A method according to claim 85 wherein the solar energy collecting system comprises a linear Fresnel reflector array.
